(19) United States
(12) Patent Application Publication
(10) Pub. No.: US 2011/0193711 A1
(43) Pub. Date: Aug. 11, 2011

(54) METHOD AND DEVICE FOR DETECTING THE PRESENCE, IN A LOAD, OF OBJECTS SUSPECTED OF CONTAINING AT LEAST ONE MATERIAL HAVING A GIVEN ATOMIC WEIGHT

(75) Inventors: Jean Michel Faugier, Chevreuse (FR); Nicolas Dumay, Dampierre En Yvelines (FR); Eric Simon, Alfortville (FR); Eric Falzon, Rungis (FR); Jean Philippe Denis, Jouy-en-Josas (FR)

(73) Assignee: SMITHS HEIMANN SAS, Vitry Sur Seine (FR)

(21) Appl. No.: 13/002,563

(22) PCT Filed: Jul. 6, 2009
(86) PCT No.: PCT/FR2009/051336

§ 371 Date: Apr. 26, 2011

(30) Foreign Application Priority Data
Jul. 4, 2008 (FR) 0854551

(51) Int. Cl. G08B 21/00; G01N 23/223; G08B 17/12

(52) U.S. Cl. 340/600; 378/45

(57) ABSTRACT

Method for detecting, in a load (2), the presence of objects suspected of containing at least one material having a given atomic weight, in which the load (2) is exposed to at least a first X-ray beam having a first spectrum and an atomic number class to which the materials, including the load through which the X-rays pass, is determined by high-energy discrimination. Furthermore, at least one g-ray or neutron beam spontaneously emitted by the load is measured, a spontaneous g and/or neutron radiation emission class of the material including the load is determined from the spontaneous radiation measurement, and a class of interest of the material of the load is determined from the atomic number class and the spontaneous radiation class that were determined.

The present invention relates to the detection of the presence in a load, of objects suspected of containing material(s) with a high atomic weight, such as materials which may have nuclear activity.

In order to detect the presence of suspected objects such as smuggled objects, weapons, explosive devices, the use of X-ray scanners is known for elaborating an image by transparence of the contents of the load. Such devices are for example used in airports for inspecting passenger luggage but they are also used in different check points, in particular in customs houses for inspecting the contents of containers or the contents of truck trailers or of any vehicles. Generally, these X-ray scanners provide a grey-level image of the contents of the loads, and recognition of the objects contained in the load is carried out by an operator who examines the images provided by the scanner.

In order to improve the detection of suspected objects, certain scanners, notably scanners intended for examining traveler luggage, are capable of carrying out so-called “low energy” discrimination which is based on the photoelectric effect by using radiations having energies of less than 150 keV. This “low energy” discrimination gives the possibility of proposing to the observer a classification of the objects by atomic number categories and may thus assist in detecting highly organic materials, such as those which are contained in explosives or on the contrary materials with high atomic number, such as nuclear products, notably SNMs (“Special Nuclear Materials”).

Certain scanners may also achieve “high energy” discrimination, based on the creation of electron-positron pairs, by using radiations having energies above 1 MeV, with the same purpose as the scanners carrying out energy-based discrimination, but adapted for examining more bulky objects than in the previous case.

Discrimination by the atomic number may be used for showing the user images on which the grey level view is superposed in transparence on the one hand, and colors indicating the atomic numbers on the other hand. This discrimination, which allows materials to be classified, however has the drawback of not distinguishing among high atomic number materials, those which are potentially suspected because of the hazard which they represent or because of any other criterion and those which are harmless. Harmless high atomic level materials are notably lead as may be found in wells and in diving ballasts, tungsten which may be found in high strength parts, tin which may be found in tableware objects, neodymium which is found in magnets, or cadmium which is found in batteries.

In order to more specifically detect the products which may have nuclear uses, such as uranium, thorium or plutonium, scanners were proposed providing devices for measuring radiation such as neutron radiation or gamma radiation. The analysis of the load is then carried out by combining the appearance of the objects and the presence of radiation or not.

This method however has the drawback of not allowing a distinction to be properly made between harmless products which nevertheless emit gamma or neutron radiations and potentially dangerous products. Harmless products which emit radiations are for example ceramics, bananas, fertilizers or further other items.

The object of the present invention is to find a remedy to these drawbacks by proposing a means for ausculting loads capable of containing suspect objects with a high atomic number, such as nuclear materials, by limiting false alarms as far as possible. This means should be able to be used for ausculting loads such as contents of containers or of truck trailers, or vehicles in general, or loosely positioned loads.

For this purpose, the object of the invention is a method for detecting in a load the presence of suspected objects containing at least one material with a given atomic weight, according to which the load is subject to at least one first X radiation having a first spectrum and an atomic number class is determined, to which belong the materials with which the load is made up, crossed by X radiations, by high energy discrimination. Additionally, at least one γ or neutron radiation spontaneously emitted by the load is measured, a γ and/or neutron spontaneous radiation emission class of the material which makes up the load, is determined from the measurement of spontaneous radiation and a class of interest of the material of the load is determined from the determined atomic number class and spontaneous radiation class.

Additionally, the load may be subject to neutron radiation, the absorption rate of which is measured, in order to contribute to said determination of the atomic number class.

Preferably, the absorption rate of the radiation and the atomic number class are determined in a plurality of areas of the load so as to form an image in transparence of the distribution of the detected classes of interest in the load.

Preferably, by a relative movement of the load and of a device for detecting the presence of suspected objects, the load is moved, between at least one X-ray emitter, and optionally a neutron emitter, and a plurality of X-ray detectors and optionally a plurality of neutron detectors, positioned along at least one line extending in an analysis plane (P) crossed by the direction of displacement of the load on the one hand, and, facing a detector of γ rays and/or neutrons adapted for carrying out an analysis per section, absorption measurements of X-rays corresponding to two spectra and measurements of spontaneous γ or neutron radiation are carried out for a plurality of successive relative positions of the load and of the device for detecting the presence of suspected objects, on the other hand and the measurements of absorption of X-rays and of γ or neutron spontaneous radiation are associated in order to establish a mapping of the class of interest of the materials with which the load is made up.

At least one X-radiation may have a maximum energy sufficient for causing photofission and, additionally a measurement of emission of neutrons resulting from photofission is carried out and the evaluation of the atomic number class, the evaluation of the emission of spontaneous γ or neutron radiation and the evaluation of neutron emission resulting from photofission are used for determining the class of interest of the material of the load.

The load may be moved between a plurality of radiation emitters and a plurality of detectors, so as to carry out a plurality of detections along a plurality of analysis planes and/or analysis directions.

From the measurements carried out by the detectors, it is possible to elaborate at least one image of the contents of the load and of the distribution of the classes of interest, which are made available to an operator.

Preferably, when the presence of a material corresponding to a class of interest which should be detected, is detected, an alarm signal is issued, for example a sound and/or visual signal.

The invention also relates to a device for applying said method which comprises at least one X-ray emitter adapted for emitting X-rays with a maximum energy of more than 1 MeV, in order to allow high energy discrimination to be carried out, at least one X-ray detector and one control and processing module connected to the X-ray emitter and to each X-ray detector. The device further comprises at least one γ or neutron radiation detector connected to the control and processing module.

Preferably, the control and processing module is adapted so that emissions of X-rays are achieved by pulses separated by sufficient time intervals in order to carry out γ ray emission measurements and to neutralize the γ radiation detector during the X-ray emissions and to enable it during the intervals between X-ray emissions.

Preferably, the X-ray detectors are positioned along a column, facing the X-ray emitter, and the device comprises a means for ensuring a relative displacement of a load to be analyzed and means for emitting X-rays and for detecting X, γ or neutron radiations, and means for associating the displacement of the load and the radiation measurements so as to associate the detection of γ or neutron radiation and the detection of a given atomic number in order to generate, if necessary, an alarm and optionally produce at least one image of the distribution in the load of the classes of materials of the load.

The device may notably be adapted in order to inspect a container or a truck trailer or a vehicle.

The invention will now be described more specifically but in a non-limiting way with regard to the appended figures wherein:

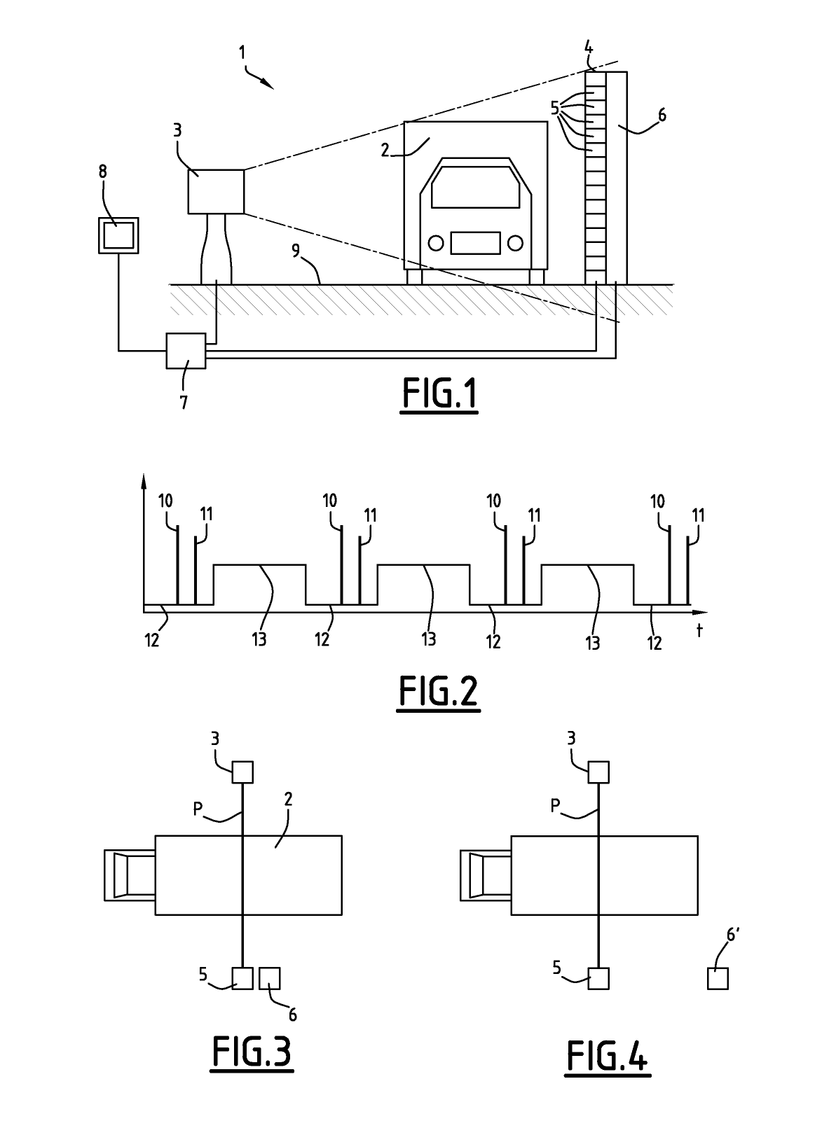

FIG. 1 schematically illustrates as a sectional view an installation intended to scan the contents of the trailer of a truck in order to detect in the load of the truck the possible presence of suspect objects;

FIG. 2 illustrates a time-dependent rate in X-ray emission and γ radiation measurement by means of a scanner illustrated in FIG. 1;

FIG. 3 shows, as seen from the top, a first embodiment of a scanner for a truck as illustrated in FIG. 1.

FIG. 4 illustrates, as seen from the top, a second embodiment of a scanner as illustrated in FIG. 1.

The invention consists in the combination of an examination in transparence by radiations with which the atomic number of the crossed materials may be evaluated, on the one hand, and of detection of spontaneous or natural radiations emitted by materials on the other hand.

The examination in transparence always comprises the use of high energy X-rays with which high energy discrimination of the atomic number may be carried out. This high energy discrimination method is known to one skilled in the art.

The examination may further comprise an examination in transparence by X radiation of higher energy, or by neutron radiation.

The detected spontaneous radiation may either be γ radiation or spontaneous neutron radiation. The presence of these radiations, the energy spectrum of which may be determined if necessary, combined with information on an atomic number class, allows determination whether it is likely or not that the examined load for example contains a potentially dangerous nuclear material or any other noteworthy material.

It should be understood that by “spontaneous radiation”, in the context of the invention, is meant both radiation resulting from natural radioactivity of the load and radiation which would be induced by X or neutron irradiation of the load.

An embodiment will now first of all be described in detail, in which the load is examined in transparence by X-rays and possible presence of γ radiation is detected.

In FIG. 1, an installation for inspecting with a scanner the contents of a truck is illustrated as a front view. The installation, generally marked with 1, intended for inspecting the contents of the load of the truck 2, consists of a device comprising an X-ray emitter 3 on the one hand and a measurement gantry 4 consisting of a plurality of X-ray detectors 5 positioned as a column facing the X-ray emitters 3 and one or more γ radiation detectors 6 each consisting of a scintillator and a photomultiplier, on the other hand. The X-ray emitter 3 and the measurement gantry 4 are separated by a circulation area 9 for the truck 2. The X-ray emitter consists of a target, for example in tungsten, and of an electron emitter for example consisting of an electron accelerator or of any other type of electron beam generator, and comprises a means for collimating the X-ray beams so that they are contained in an analysis plane P. The electron beam generator is adapted so as to be able to generate electron beams accelerated under a voltage of 2 megavolts (MV) and electron beams accelerated under voltages of 6 MeV so as to be able to generate X-ray beams, the maximum energy of which is 6 MeV on the one hand and X-ray beams, the maximum energy of which is 2 MeV on the other hand. The X-ray emitter 3 is connected to a control module 7 which itself is also connected to the whole of the X-ray detectors 5 on the one hand, and to the γ ray detector 6 on the other hand. The control module is also connected to a station 8 for viewing the contents of the truck. In an embodiment illustrated in FIG. 3, the column 4 of X-ray detectors 5 and the γ radiation detector 6 are positioned side by side, so that only the column of X-ray detectors is located facing the X-ray emitter 3. In the second embodiment, illustrated in FIG. 4, only the column of X-ray detectors 5 is located facing the X-ray generator, and the detector 6′ of γ rays is located out of the way and for example relocated at the end of the inspection installation.

In both cases, the truck may move past the X-ray generators by crossing the analysis plane P. In order to ensure displacements of the truck past the X-ray generator, a device may be used which is not illustrated in the figure but of which one skilled in the art is aware.

In a first embodiment, the device comprises a platform on which a truck is laid, the platform being motorized so as to be able to move past the X-ray generator, and preferably the movements of which are recorded in real time, this recoding of the displacements being transmitted to the control module 7.

In a second embodiment, which is also known to one skilled in the art, the truck is still and the scanning device consisting of the X-ray emitter 3 and of the X-ray detectors 5 and of the γ radiation detector 6 is grouped on a gantry which may move along the truck. In this second embodiment, the movements of the gantry are preferably recorded in real time and transmitted to the control module 7.

Other architectures are further possible and one skilled in the art may easily devise them. Indeed it is sufficient to provide means allowing the truck to move past means for X-ray examination by transparence on the one hand and means for detecting γ radiations, these means being adapted so as to be able to be associated with the positions at which the measurements are conducted and with the actual measurements.

In order to auscult the contents of the truck in order to detect in the load of the latter the possible presence of suspect objects for example which may be used for nuclear purposes, a relative movement of the truck and of the scanning device is achieved so as to have the whole of the load pass between the X-ray emitter and the X and γ radiation detectors and the truck is successively subject to bombardment by X-radiation having a maximum energy level of 2 MeV, and X-radiation having a maximum energy of 6 MeV, and by means of X-ray sensors 5, the amount of transmitted X-rays is measured for beams with a maximum energy of 2 MeV on the one hand, and for beams with a maximum energy of 6 MeV on the other hand. This allows determination of the absorption rate of radiations with a maximum energy of 2 MeV, on the one hand and with a maximum energy of 6 MeV, on the other hand, by materials which are located on lines running from the X-ray emitter 3 as far as one of the X-ray sensors 5. By recording these values and transmitting them to the control module 7, optionally coupled with transmission of the position of the scanning device relatively to the vehicle at the moment of the measurement, a mapping may be achieved of the absorption rate of the X-radiations by the objects contained in the load of the truck. This method for elaborating a mapping of the absorption rate of X-rays by the object contained in the load is known per se to one skilled in the art. It may be used for producing the transparence image of the contents of the load of the truck and for displaying it for example on the viewing screen 8. Of course, in order to achieve this scanning with two X-ray beams of different energies, high energy X-rays and lower energy X-rays are generated successively, so as to generate successive pulses. Moreover, from absorption data of radiations with a maximum energy of 2 MeV and of radiations with a maximum energy of 6 MeV, the atomic number of the materials which have been crossed by radiation may be determined. Indeed, by comparing the ratio of the absorption rate of the radiation with a maximum energy of 2 MeV with the absorption rate of the radiation with a maximum energy of 6 MeV, and by comparing this ratio to the ratio which is obtained by means of calibration achieved from a sample, for example in tin, a class of atomic numbers of the materials which have been crossed by the X-radiations may be determined. The radiation of maximum energy 2 MeV interacts with matter through the Compton effect while the radiation with a maximum energy of 6 MeV interacts with matter by forming electron-positron pairs. The absorption rates depend on the matter density but the absorption rate of radiations by formation of electron-positron pairs also depends on the atomic numbers of the elements with which the crossed materials are made up. Consequently, by comparing the ratio of the absorption rates of the radiations with a maximum energy of 2 MeV to radiations with an absorption rate of radiations with a maximum energy of 6 MeV for a same point, it is possible to determine a class of atomic numbers and thereby discriminate materials with high atomic numbers from materials which have lower atomic numbers. This method for evaluating the atomic number by X-radiation absorption is what one skilled in the art calls “high energy discrimination”.

With such devices and by means of an algorithm of use known to one skilled in the art, for example four categories of crossed materials are determined depending on the atomic number. These four categories are materials of organic nature on the one hand, so-called intermediate materials on the other hand, and then metal but non-nuclear materials and finally materials with high atomic numbers which may be nuclear materials such as uranium, thorium, or plutonium, but also harmless elements such as lead, tungsten, tin, neodymium and cadmium. With this information on the class of atomic numbers, it is possible to produce color illustrations on the image which is projected on the viewing screen 8. Indeed, a color may be assigned to each class of atomic numbers, which gives the possibility of obtaining images on which are seen in transparence the shape of the crossed objects on the one hand and a color which indicates the class of atomic numbers of the materials with which these objects are made up, on the other hand. In the embodiment which has just been described, beams are selected having maximum energies of 2 MeV and 6 MeV. One skilled in the art will understand that other energy levels are possible. What is important is to be able to carry out absorption measurements resulting from a Compton effect on the one hand and from the formation of electron-positron pairs on the other hand. For this, the maximum energy level of the first beam is advantageously comprised between 1 and 5 MeV and the energy level of the second beam is greater than 4 MeV and may sometimes exceed 15 MeV.

In the embodiment of the examination in transparence which has just been described, high and low energy X-ray beams are caused to alternate. But other embodiments are possible. For example two distinct X-ray sources may be provided, one with a high energy and the other with a low energy. It is also possible to use a filtration method known to one skilled in the art, in which a single beam with a high maximum energy is used and two series of successive detectors separated by a filter are used so that the first series of detectors receives the whole transmitted beam, while the second series of detectors only receives the most energetic portion of this beam.

Moreover, by means of the γ ray detector 6, 6′, which in the illustrated example consists of a large-size scintillator and of a photomultiplier, the γ radiation emitted by the load of the truck is recorded. This radiation is recorded according to slices which move past the detector and the intensity of the emitted γ radiation is associated with the relative position of the truck and of the scanning device at the moment when the measurement is carried out. Thus, the image illustrating the objects contained in the load of the truck, comprising the indication of the atomic number class may be completed with an emission indication of γ radiations. Such devices for measuring emission of γ radiations are known per se to one skilled in the art. The γ radiation detector 6, 6′ may, as this is illustrated in FIG. 3, be positioned beside the X-ray detector column, or as illustrated in FIG. 4, be away from the X-ray emission area. In the first case, the scintillator receives significant fluxes of X-rays. In the second case, the X-ray flux received by the scintillator is much weaker.

In every case, in order to be able to carry out measurements under good conditions, it is necessary to neutralize the photomultiplier of the γ radiation detector, when the device emits X radiations in order not to saturate the photomultiplier. This neutralization may be carried out by a software or hardware means known per se to one skilled in the art.

As this is illustrated in FIG. 2, the target is illuminated with a succession of high energy X-radiation peaks 10 and with a succession of X-radiation peaks 11 of lower maximum energy. Emissions of peaks of X radiations of high or low energy are carried out for periods 12, during which the power supply of the photomultipliers of the γ radiation detector is cut off in order to make it inactive and thereby carry out the aforementioned neutralization. Between two successive periods of X-radiation emission, during a time interval 13, the electric power supply of the photomultiplier of the γ radiation detector gamma is re-activated so as to be able to carry out γ radiation measurements. Thus, during the periods 12, X-ray absorption measurements are carried out and during the intermediate periods 13, γ radiation measurements are carried out, which are not perturbed by X-radiation emissions.

As indicated earlier, by associating X radiation absorption and γ radiation emission measurements on the one hand, and measurements of the relative displacement of the load and of the scanner device on the other hand, an image is obtained with which it is possible, point by point, to give characteristics of the objects contained in the load of the vehicle, which are their transparence to X-rays on the one hand, an atomic number class on the other hand, and finally a γ radiation emission rate. In order to ensure this synchronization, the relative displacement of the scanner device and of the load may be recorded with any known sensors and for example with a telemeter. One skilled in the art is aware of devices which are capable of tracking in real-time the relative displacement of the scanning devices and of the load during scanning, in order to provide the control means 7, with information allowing reconstruction of the images of the contents of the load of the truck.

By means of the information relating to the transparence to X-rays, on the one hand, to the atomic number class of the materials on the other hand and, finally, to the γ radiation emission rate, it is possible to determine whether the load contains suspect objects or not, for example likely to be hazardous since they consist of or contain materials of the nuclear type, such as uranium, thorium or plutonium. Indeed, these materials are characterized by high atomic numbers on the one hand and by significant γ emissions on the other hand. With this combination of several characteristics, it is possible to ensure good discrimination of the nature of the materials and in particular distinguish these materials of a nuclear type from materials which are also emitters of γ rays, such as ceramics or bananas which are characterized by much smaller atomic numbers than materials of the uranium, plutonium or thorium type. In order to determine whether these materials are suspect or not, it is possible to use either simple algorithms which compare predetermined thresholds of atomic numbers and predetermined thresholds of γ radiation emission, which may moreover be also compared with X-radiation absorption rates, or else by using more complex algorithms of the neuronal network type comprising learning phases beforehand. One skilled in the art is aware of this type of algorithm for using measurements in order to detect the more or less suspect nature of an object contained in the load by means of thereby obtained information. It is then possible to generate alarms for the operators, which may be visual alarms and/or sound alarms.

In this way, it is possible to determine whether a detected object belongs to a <<class of interest>>, i.e. whether it is likely to consist of or contain hazardous materials or which may cause suspicion that it is of a nature making its presence undesirable in the load for any reason, according to predefined criteria by the operator.

In the embodiment which has just been described, the transparence analysis is carried out by X-rays. But an X-ray transparence analysis may be associated with a single beam of X-rays and a transparence analysis with neutrons. In this case, the load is subject to neutron radiation, which is added to the aforementioned X radiation. In this way, determination of the atomic number class is carried out by utilizing the absorptions of both types of radiation by the load. One skilled in the art knows how to select the transparence analysis means which are the most suitable for each case.

Additionally, instead of measuring spontaneous γ radiation, or as an addition to this measurement, it is possible to measure possible spontaneous neutron radiation which is very characteristic of the presence of certain materials such as radioactive plutonium. For this, neutron detectors known per se are used.

In order to complete this detection with the atomic number on the one hand, with natural γ radiation on the other hand or spontaneous neutron radiation, it is possible to provide a means for measuring neutron radiation in order to measure neutron radiation resulting from photon excitation. For this, an X-ray emitter capable of emitting radiations for which the maximum energy is of at least 9 MeV and a neutron detector is positioned beside the X-ray detectors. This additional method is based on the physical photofission phenomenon which corresponds to the fission of certain materials resulting from bombardment by high energy X-radiation, which generates neutron emission.

One skilled in the art is aware of the conditions under which neutron radiation may be generated in this way.

The device which has just been described comprises a γ ray detector extending on one side of the area through which pass the trucks to be inspected. This γ ray detector has a large surface so as to be able to detect relatively weak radiations. In order to improve the sensitivity of this device, provision may be made for a γ radiation detector which forms a gantry surrounding the area through which pass the trucks, the contents of which is intended to be examined.

The device which has just been described is a device which allows auscultation of the contents of a truck, but provision may also be made for devices for osculating the contents of trailers or containers such as those which are loaded onboard ships, or any other load positioned in a container or loose. In this case, the device comprises means for relatively displacing the load to be inspected and the X-ray emitter.

Finally, a device which allows an image to be produced by transparence of the contents of a load has just been described, but it is possible to provide devices which just carry out an overall inspection of the contents of a load and just emit an alarm simply when conditions of a possible presence of suspect materials inside the load are detected, without providing an image of the load which would allow localization of said suspect materials therein.

Provision may also be made for carrying out a plurality of examinations, under different angles or in different directions. For example, provision may be made for an examination from the side or an examination from the top of the load. For this it is sufficient to provide adapted arrangements of the radiation emitters and detectors, or if possible, means with which the orientation of the load may be modified so as to be able to inspect it according to several angles with a single assembly of emitters and receivers.

It is obvious that the invention may be adapted to the auscultation of the contents of the load of any receptacle (container . . . ) and of any road, railway, airborne or seaworthy vehicle, or of a loosely positioned load, not contained in a container.

1. A method for detecting in a load (2) the presence of suspect objects containing at least one material with a given atomic weight, according to which the load (2) is subject to at least one first X-radiation having a first spectrum and an atomic number class is determined to which belong the materials with which the load crossed by the X-radiations is made up, by high energy discrimination, characterized in that at least one γ or neutron radiation spontaneously emitted by the load is measured, an emission class of γ and/or neutron spontaneous radiation of the material making up the load is determined from measuring spontaneous radiation and a class of interest of the material of the load is determined from the determined atomic number class and from the determined spontaneous radiation class.

2. The method according to claim 1, characterized in that the load is further subject to neutron radiation, the absorption rate is measured, in order to contribute to said determination of the atomic number class.

3. The method according to claim 1, characterized in the absorption rate of the radiation and the atomic number class are determined in a plurality of areas of the load so as to form an image in transparence of the distribution of the detected classes of interest in the load.

4. The method according to claim 3, characterized in that, by a relative movement of the load and of a device for detecting the presence of suspect objects, the load is moved between at least one X-ray emitter and optionally a neutron emitter, and a plurality of X-ray detectors and optionally a plurality of neutron detectors on the one hand, positioned along at least one line extending in an analysis plane (P) crossed by the direction of movement of the load, and facing a detector of γ rays and/or neutrons adapted for carrying out an analysis per section, on the other hand, measurements of absorption of X-rays corresponding to two spectra and measurements of γ or neutron spontaneous radiation are carried out for a plurality of successive relative positions of the load and of the device for detecting the presence of suspect objects, and the measurements of X-radiation absorption and of γ or neutron spontaneous radiation are associated in order to establish a mapping of the class of interest of the materials with which the load is made up.

5. The method according to claim 1, characterized in that at least one X radiation has a sufficient maximum energy for causing photofission and in that a measurement of neutron emission resulting from the photofission is carried out and in that the evaluation of the atomic number class, the evaluation of the emission of γ or neutron spontaneous radiation and the evaluation of emission of neutrons resulting from photofission are used for determining the class of interest of the material of the load.

6. The method according to claim 1, characterized in that the load is moved between a plurality of radiation emitters and a plurality of detectors, so as to carry out a plurality of detections along a plurality of analysis planes and/or analysis directions.

7. The method according to claim 3, characterized in that from measurements carried out by the detectors, at least one image of the contents of the load and of the distribution of the classes of interest is elaborated, which is made available to an operator.

8. The method according to claim 1, characterized in that when the presence of a material corresponding to a class of interest which should be detected, is detected, an alarm signal is issued, a sound and/or visual signal for example.

9. A device for applying the method according to claim 1, of the type comprising at least one X-ray emitter (3) adapted for emitting X-rays with a maximum energy of more than 1 MeV, in order to be able to carry out high energy discrimination, at least one X-ray detector (5), a control and processing module (7) connected to the X-ray emitter and to each X-ray detector, characterized in that it further comprises at least one γ or neutron radiation detector (6) connected to the control and processing module.

10. The device according to claim 9, characterized in that the control and processing module (7) is adapted so that the emissions of X-rays are carried out by pulses (10, 11) separated by time intervals (13) sufficient for carrying out measurements of emission of γ radiation and for neutralizing the γ radiation detector during the X-ray emissions and activating it during the intervals (13) between emissions of X-rays.

11. The device according to claim 9, characterized in that the X-ray detectors (5) are positioned along a column, facing the X-ray emitter (3), in that the device comprises a means for ensuring relative displacement of a load to be analyzed and means for emitting X-rays and for detecting X, γ or neutron radiations, and means for associating the displacement of the load and the radiation measurements so as to associate the detection of γ or neutron radiation and the detection of a given atomic number in order to generate, if necessary, an alarm and optionally provide at least one image of the distribution in the load of the classes of interest of the materials of the load.

12. The device according to claim 9, characterized in that it is adapted for inspecting a container or a truck trailer or a vehicle.

13. The method according to claim 2, characterized in the absorption rate of the radiation and the atomic number class are determined in a plurality of areas of the load so as to form an image in transparence of the distribution of the detected classes of interest in the load.

14. The method according to claim 13, characterized in that, by a relative movement of the load and of a device for detecting the presence of suspect objects, the load is moved between at least one X-ray emitter and optionally a neutron emitter, and a plurality of X-ray detectors and optionally a plurality of neutron detectors on the one hand, positioned along at least one line extending in an analysis plane (P) crossed by the direction of movement of the load, and facing a detector of γ rays and/or neutrons adapted for carrying out an analysis per section, on the other hand, measurements of absorption of X-rays corresponding to two spectra and measurements of γ or neutron spontaneous radiation are carried out for a plurality of successive relative positions of the load and of the device for detecting the presence of suspect objects, and the measurements of X-radiation absorption and of γ or neutron spontaneous radiation are associated in order to establish a mapping of the class of interest of the materials with which the load is made up.

15. The method according to claim 2, characterized in that at least one X radiation has a sufficient maximum energy for causing photofission and in that a measurement of neutron emission resulting from the photofission is carried out and in that the evaluation of the atomic number class, the evaluation of the emission of γ or neutron spontaneous radiation and the evaluation of emission of neutrons resulting from photofission are used for determining the class of interest of the material of the load.

16. The method according to claim 2, characterized in that the load is moved between a plurality of radiation emitters and a plurality of detectors, so as to carry out a plurality of detections along a plurality of analysis planes and/or analysis directions.

17. The method according to claim 2, characterized in that when the presence of a material corresponding to a class of interest which should be detected, is detected, an alarm signal is issued, a sound and/or visual signal for example.

18. A device for applying the method according to claim 2, of the type comprising at least one X-ray emitter (3) adapted for emitting X-rays with a maximum energy of more than 1 MeV, in order to be able to carry out high energy discrimination, at least one X-ray detector (5), a control and processing module (7) connected to the X-ray emitter and to each X-ray detector, characterized in that it further comprises at least one γ or neutron radiation detector (6) connected to the control and processing module.

19. The device according to claim 10, characterized in that the X-ray detectors (5) are positioned along a column, facing the X-ray emitter (3), in that the device comprises a means for ensuring relative displacement of a load to be analyzed and means for emitting X-rays and for detecting X, γ or neutron radiations, and means for associating the displacement of the load and the radiation measurements so as to associate the detection of γ or neutron radiation and the detection of a given atomic number in order to generate, if necessary, an alarm and optionally provide at least one image of the distribution in the load of the classes of interest of the materials of the load.

20. The device according to claim 10, characterized in that it is adapted for inspecting a container or a truck trailer or a vehicle.
